(19) United States
(12) Patent Application Publication
(10) Pub. No.: US 2009/0161278 A1
(43) Pub. Date: Jun. 25, 2009

(54) SHORT-CIRCUIT PROTECTION CIRCUIT

(75) Inventor: CHUAN-TSAI HOU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/039,641

(22) Filed: Feb. 28, 2008

(30) Foreign Application Priority Data
Dec. 19, 2007 (CN) 200710203241.6

(51) Int. Cl. H02H 3/08; H02H 9/02

(52) U.S. Cl. 361/93.7; 361/101

(57) ABSTRACT

A short-circuit protection circuit includes a power supply, a first resistor, and an optocoupler. The optocoupler includes a light-emitting diode and a phototransistor, one end of the first resistor is connected to the anode of the power supply and the other end of the first resistor is connected to the anode of the light-emitting diode, the cathode of the light-emitting diode is grounded, the collector of the phototransistor is connected to the anode of the power supply, and the emitter of the phototransistor is grounded via a load circuit, the cathode of the power supply is grounded, when a short circuit occurs in the load circuit, the light-emitting diode turns off, the phototransistor turns off accordingly, and the voltage of the power supply does not provide voltage to the load circuit.

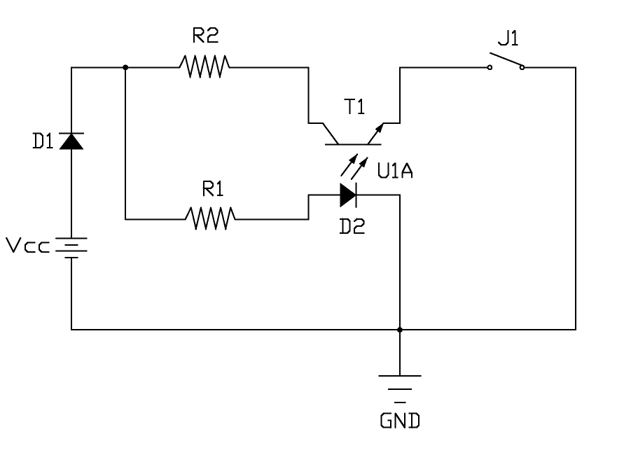

### BACKGROUND

1. Field of the Invention

The present invention relates to protection circuits, and particularly to a short-circuit protection circuit.

2. Description of Related Art

It is very important that electronic devices perform well, however, a short circuit in any part of the electronic devices can cause damage, such as burning circuits in the electronic devices and thus cause financial loss to the user. At present, the general design of short-circuit protection circuits on the market usually use a metal oxide semiconductor field effect transistor (MOSFET) or some relays, which is costly.

What is needed, therefore, is a short-circuit protection circuit which can solve the above problems.

### SUMMARY

An embodiment of a short-circuit protection circuit includes a power supply, a first resistor, and an optocoupler. The optocoupler includes a light-emitting diode and a phototransistor. One end of the first resistor is connected to the anode of the power supply and the other end of the first resistor is connected to the anode of the light-emitting diode. The cathode of the light-emitting diode is grounded, the collector of the phototransistor is connected to the anode of the power supply, the emitter of the phototransistor is grounded via a load circuit. and the cathode of the power supply is grounded. When a short circuit occurs in the load circuit, the light-emitting diode turns off, the phototransistor turns off, and thus the power supply does not provide voltage to the load circuit.

Other advantages and novel features of the present invention will become more apparent from the following detailed description of preferred embodiment when taken in conjunction with the accompanying drawing, in which:

### BRIEF DESCRIPTION OF THE DRAWINGS

The drawing is a circuit diagram of a short-circuit protection circuit in accordance with an embodiment of the present invention.

### DETAILED DESCRIPTION

Referring to the drawing, a short-circuit protection circuit in accordance with an embodiment of the present invention includes a power supply Vcc, a diode D1, a first resistor R1, a second resistor R2, and an optocoupler U1A. The optocoupler U1A includes a light-emitting diode D2 and a phototransistor T1. The anode of the diode D1 is connected to the anode of the power supply Vcc, the cathode of the power supply Vcc is grounded. One end of the first resistor R1 is connected to the anode of the diode D1, the other end of the first resistor R1 is connected to the anode of the light-emitting diode D2, and the cathode of the light-emitting diode D2 is grounded. One end of the second resistor R2 is connected to the cathode of the diode D1, the other end is connected to the collector of the phototransistor T1, and the emitter of the phototransistor T1 is grounded via a load circuit. In this embodiment, a switch J1 is adopted in the load circuit to simulate a short-circuit.

When the switch J1 is open, which is equivalent to the load circuit working normally, the power supply Vcc provides a positive bias to the optocoupler U1A, so the light-emitting diode D2 turns on and emits light, the phototransistor T1 turns on accordingly, and the voltage of the power supply Vcc is applied to the load circuit.

When the switch J1 is closed, which is equivalent to the load circuit having a short-circuit, the voltage at the switch J1 is 0V, and the voltage at the left end of the resistor R2 is 0V instantly, so the light-emitting diode turns off, the phototransistor T1 turns off, and the voltage of the power supply Vcc is no longer applied to the load circuit.

The configuration of the short-circuit protection circuit is simple, easily manufactured, and instantly isolates a load in the case of a short circuit thereby protecting an electronic device adopting the short-circuit protection circuit.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A short-circuit protection circuit comprising:
a power supply having an anode and a grounded cathode;
a first resistor connected to the anode of the power supply; and
an optocoupler having a light-emitting diode and a phototransistor, the anode of the light-emitting diode connected to the power supply via the first resistor, the cathode of the light-emitting diode grounded, the collector of the phototransistor connected to the anode of the power supply, and the emitter of the phototransistor grounded via a load circuit, wherein, when there is no short circuit present in the load circuit the light-emitting diode is on, accordingly the phototransistor is on, and the power supply provides voltage to the load circuit, if a short circuit occurs in the load circuit, the light-emitting diode turns off, the phototransistor turns off, and the power supply does not provide voltage to the load circuit.

2. The short-circuit protection circuit as claimed in claim 1, wherein the anode of the power supply is connected to the first resistor via a diode, the anode of the diode is connected to the anode of the power supply, the cathode of the diode is connected to the first resistor.

3. The short-circuit protection circuit as claimed in claim 2, wherein the cathode of the diode is connected to the collector of the phototransistor via a second resistor.

4. The short-circuit protection circuit as claimed in claim 1, wherein the anode of the power supply is connected to the collector of the phototransistor via a second resistor.
